(19) United States
(12) Patent Application Publication
(10) Pub. No.: US 2026/0233449 A1
(43) Pub. Date: Aug. 13, 2026

(54) Fluid Guide Block and Heating and Cooling Module

(71) Applicant: Rheinmetall Invent GmbH, Neuss (DE)

(72) Inventors: Karl-Heinz Hassel, Ostringen (DE); Didier Manning, Ditzingen (DE); Dagmar Böhringer, Bretzfeld (DE); Andreas Gorzel, Auenwald (DE); Alexej Urban, Zürich (CH)

(21) Appl. No.: 19/538,190

(22) Filed: Feb. 12, 2026

(30) Foreign Application Priority Data
Feb. 13, 2025 (DE) 10 2025 105 449.5

(51) Int. Cl. B29C 48/09

(52) U.S. Cl. CPC B29C 48/09

(57) ABSTRACT

A fluid guide block for a heating and cooling module, includes a fluid guide block element, a fluid guide block cover attached thereto, and a fluid circuit arranged within the fluid guide block for guiding a fluid through the fluid guide block. The fluid guide block element is an extruded component. At least one fluid line section of the fluid circuit extends parallel to an extrusion direction of the fluid guide block element and is formed by plastic deformation on the fluid guide block element. At least one fluid line section of the fluid circuit extends transversely to the extrusion direction and is in fluid communication with the at least one fluid line section extending parallel to the extrusion direction. The fluid guide block element or the fluid guide block cover circumferentially closes the at least one fluid line section extending transversely to the extrusion direction.

### CROSS-REFERENCE TO RELATED APPLICATIONS

This application claims priority benefit to German Patent Application No. 102025105449.5 filed Feb. 13, 2025, the contents of which is incorporated herein by reference in the entirety for all purposes.

### TECHNICAL FIELD

The present invention relates to a fluid guide block for a heating and cooling module and to a heating and cooling module comprising such a fluid guide block.

### BACKGROUND

Components of air conditioning systems and heat pumps require a diffusion-tight and pressure-resistant connection. For this purpose, metal pipes can be used, which usually form a closed fluid circuit for a refrigerant and/or coolant circulating in the fluid circuit by means of soldered or welded connections and/or flange connections in conjunction with sealing rings. However, such connection techniques are only conditionally reliable, since soldered connections, for example, are highly dependent on the selected process parameters and are also very costly and require a large installation space. In addition, the number of connection points increases the risk of leaks and thus the risk of climate-damaging refrigerants being released into the surroundings.

### SUMMARY

Against this background, one problem of the present invention is to provide an improved fluid guide block.

Accordingly, a fluid guide block for a heating and cooling module is proposed. The fluid guide block comprises a fluid guide block element, a fluid guide block cover attached to the fluid guide block element, and a fluid circuit arranged within the fluid guide block for guiding a fluid through the fluid guide block, wherein the fluid guide block element is an extruded component, wherein at least one fluid line section of the fluid circuit extends parallel to an extrusion direction of the fluid guide block element and is formed by plastic deformation on the fluid guide block element, wherein at least one fluid line section of the fluid circuit extends transversely to the extrusion direction, wherein the at least one fluid line section extending transversely to the extrusion direction is in fluid communication with the at least one fluid line section extending parallel to the extrusion direction, wherein the at least one fluid line section extending transversely to the extrusion direction is groove-shaped, and wherein the fluid guide block element or the fluid guide block cover circumferentially closes the at least one fluid line section extending transversely to the extrusion direction.

Because the fluid line section extending along or parallel to the extrusion direction is formed by plastic deformation onto the fluid guide block element, it is possible to manufacture the fluid guide block element cost-effectively as an extruded component, in particular as an extrusion molded component, and at the same time to arrange the fluid circuit within the fluid guide block. This results in reliable production, a small size with high power density, and a high degree of flexibility, for example with regard to the possible applications of the fluid guide block. A diffusion-tight fluid circuit with the smallest possible number of potential leak points is created. Furthermore, the amount of fluid circulating in the fluid circuit can be reduced due to the absence of external piping.

In this context, a "fluid circuit" refers to a device or assembly in which the fluid, for example a coolant or a refrigerant, can circulate or through which the fluid can flow. The fluid circuit can in particular be a cavity formed within the fluid guide block. The fluid circuit can be formed by any number of cavities, in particular by any number of fluid line sections, within the fluid guide block. The fluid circuit can be arranged completely within the fluid guide block. However, the fluid circuit can also be placed at least partially outside the fluid guide block.

The fluid circuit can comprise any number of fluid line sections extending along or parallel to the extrusion direction, as well as any number of fluid line sections extending transversely to the extrusion direction. The fluid circuit is formed with the aid of the fluid line sections extending along or parallel to the extrusion direction and with the aid of the fluid line sections extending transversely to the extrusion direction. The fluid line sections extending along or parallel to the extrusion direction and the fluid line sections extending transversely to the extrusion direction can be arranged alternately.

The fluid circuit may also comprise, for example, a suction line and/or a pressure line of a compressor of the heating and cooling module, which may be arranged at least partially outside the fluid guide block. Furthermore, the fluid circuit may also comprise buffer storage valves, compressor valves, changeover valves, two-way valves, expansion valves, bypass valves, a compressor as mentioned above, filters, a recycling unit, heat exchangers, and/or any other components of a heat pump. The aforementioned components can also be generally referred to as components of the fluid circuit or the heating and cooling module.

The term "fluid" refers in particular to a liquid. However, this does not exclude the possibility that the fluid can be converted from a liquid state to a gaseous state and vice versa by means of a phase change or phase transition. After a phase transition from liquid to gaseous, the fluid is then a gas. The fluid can become gaseous by evaporating. In the process, the fluid absorbs heat. The fluid can release the absorbed heat again through a renewed phase transition from gaseous to liquid. In the process, the fluid condenses. For the phase transitions, the heating and cooling module can comprise one or more heat exchangers that are connected to the fluid circuit or are part of the fluid circuit. One heat exchanger can function as an evaporator and another heat exchanger as a condenser.

The fluid flowing through the fluid circuit is preferably a refrigerant. However, the fluid may also be a coolant. Examples of refrigerants that may be used include 1,1,1,2-tetrafluoroethane (R-134a), carbon dioxide (R744), or any other suitable refrigerant. When the heating and cooling module is in operation, the fluid flows through the fluid circuit. A "refrigerant" transports enthalpy from a cooled object to the surroundings. The difference to a coolant is that a refrigerant in a refrigeration circuit can transport enthalpy along a temperature gradient, so that, with the application of supplied energy, an ambient temperature may even be higher than the temperature of an object to be cooled, whereas a coolant is only capable of transporting enthalpy in a cooling circuit against the temperature gradient to a location with a lower temperature. Examples of coolants are water or oil.

In the present case, the fluid is preferably a refrigerant. Accordingly, the terms "fluid" and "refrigerant" can be used interchangeably in the present case. Accordingly, the fluid guide block can also be referred to as a refrigerant guide block. Accordingly, the terms "fluid guide block" and "refrigerant guide block" can be used interchangeably in the present case. Thus, the terms "fluid circuit" and "refrigerant circuit" can also be used interchangeably.

The fluid guide block is block-shaped or plate-shaped. "Block-shaped" means in this context that the fluid guide block is cuboid or box-shaped. "Plate-shaped" means that the thickness of the fluid guide block is significantly smaller than its width and height. A plate-shaped fluid guide block is particularly preferred. The fluid guide block can therefore also be referred to as a fluid guide plate. This means that the terms "fluid guide block" and "fluid guide plate" can be used interchangeably.

The fluid guide block guides or routes the fluid during operation of the heating and cooling module. The fluid guide block can therefore also be referred to as a fluid route block or a fluid route plate. This means that the terms "fluid guide block," "fluid route block," and "fluid route plate" can be used interchangeably.

The fluid guide block is preferably multi-part, in particular three-part. The fluid guide block is formed in particular by the fluid guide block element, a first fluid guide block cover, and a second fluid guide block cover. The fluid guide block element is arranged between the first fluid guide block cover and the second fluid guide block cover, so that the first fluid guide block cover and the second fluid guide block cover are each arranged at an end of the fluid guide block element.

A material from which the fluid guide block element, the first fluid guide block cover, and/or the second fluid guide block cover are made may be, in particular, a metal alloy, particularly preferably a light metal alloy, such as an aluminum alloy or a magnesium alloy. However, the material may also be a plastic material. Suitable plastic materials include, for example, polyether ether ketones (PEEK). However, a metallic material is particularly preferred.

Preferably, the fluid line sections extending along or parallel to the extrusion direction are arranged within the fluid guide block element, whereas the fluid line sections extending transversely to the extrusion direction are arranged within the first fluid guide block cover and/or within the second fluid guide block cover and are thus placed outside the fluid guide block element. Alternatively, however, it is also possible for the fluid line sections extending transversely to the extrusion direction to be arranged within the fluid guide block element. In this case, however, it is preferable that no transverse bores be provided between the fluid line sections arranged within the fluid guide block element that run along or parallel to the extrusion direction. In other words, the fluid guide block element is preferably without transverse bores or free of transverse bores.

The fluid guide block preferably comprises a first end face, against which the first fluid guide block cover rests, and a second end face, against which the second fluid guide block cover rests. The fluid line sections extending along or parallel to the extrusion direction run from the first end face to the second end face and are open towards both the first end face and the second end face. In the event that the fluid line sections extending transversely to the extrusion direction are arranged within the fluid guide block element, they are incorporated into the first end face and/or the second end face as groove-shaped recesses.

The fact that the fluid guide block element is an "extrusion component" means in this case that the fluid guide block element is manufactured using an extrusion process. In this case, "extrusion" refers to a manufacturing process in which a plastically deformable mass, in particular a semi-finished product or a raw part of the fluid guide block element, is continuously pressed out under pressure from a shaping opening, for example from an opening in a die.

If the fluid guide block element is made of a metal alloy, the fluid guide block element is, in particular, an extrusion molded component. Accordingly, the terms "extruded component" and "extrusion molded component" can be used interchangeably in the present case. Extrusion can be regarded as a generic term for extrusion molding, so that extrusion molding is to be understood as a special form of extrusion. Accordingly, the fluid guide block element can also be referred to as a fluid guide block extrusion molded component. "Extrusion molding" is a primary forming process for producing profiles as continuous components. In this context, "continuous" refers to lengths of up to 60 m, for example. In extrusion molding, a billet heated to forming temperature is pressed through an opening in a die using a punch. Extrusion molding is therefore used to produce continuous material that can be cut to the desired length.

The fluid guide block element is therefore preferably manufactured using a primary forming or plastic deformation process. In plastic deformation production processes, raw parts made of a plastic deformable material are deliberately reshaped without removing or adding material from the raw parts. In primary forming production processes, a solid body with a geometrically defined shape is produced from a shapeless material. According to DIN 8583, extrusion is classified as a plastic deformation forming manufacturing process. DIN 8580, on the other hand, classifies extrusion as a primary forming manufacturing process. In accordance with DIN 8583, extrusion is assumed to be a plastic deformation manufacturing process.

The extrusion direction is assigned to the fluid guide block element. The extrusion direction can also be referred to as the extrusion molding direction. In this context, the "extrusion direction" refers to the direction in which the fluid guide block element is manufactured. In other words, the "extrusion direction" is the direction in which a semi-finished product or raw part for manufacturing the fluid guide block element is pressed through the aforementioned opening of the die.

The fluid guide block element is manufactured along the extrusion direction as a continuous component and then cut to the desired length and finished. Microscopically, manufacture by extrusion can be verified by the surface structure of the fluid guide block element and/or a microstructure within the fluid guide block element.

During extrusion, the geometry of the fluid guide block element, in particular both its external and internal geometry, is determined with the aid of the opening in the die. With the aid of the opening in the die, both an external contour and an internal contour of the fluid guide block element can be produced. The inner contour is formed by the fluid line sections extending along or parallel to the extrusion direction. The fluid line sections extending along or parallel to the extrusion direction are thus molded directly onto the fluid guide block element during its manufacture.

In this context, the fact that the fluid line sections extending along or parallel to the extrusion direction are formed onto the fluid guide block element by "plastic deformation" means in particular that the fluid line sections extending along or parallel to the extrusion direction are already formed onto the fluid guide block element during extrusion, in particular during extrusion molding, of the fluid guide block element. Downstream processing of the fluid guide block element to produce the fluid line sections extending along the extrusion direction is not necessary.

The fluid guide block element can thus be manufactured as a continuous endless component. To manufacture the fluid guide block element, a pre-extruded blank of the fluid guide block element is cut to the desired length, whereby the two end faces can be reworked, for example, to incorporate the fluid line sections extending transversely to the extrusion direction into the end faces.

The fluid guide block is preferably multi-part. In contrast, the fluid guide block element itself is preferably integral or monolithic. This means that the fluid guide block element is not assembled from different individual components but is designed as a single continuous component. In particular, the fluid guide block element is a monolithic component. In other words, the fluid guide block element is made entirely of the same material. The fluid line sections run along or parallel to the extrusion direction within this material.

In addition to the extrusion direction, the fluid guide block element is preferably assigned a width direction and a thickness direction. Furthermore, the fluid guide block element may be assigned a height direction. The height direction corresponds to the extrusion direction. The width direction is oriented perpendicular to the extrusion direction, whereby the thickness direction is oriented both perpendicular to the extrusion direction and perpendicular to the width direction. Viewed along the width direction, the fluid guide block element comprises a greater geometric extension, in particular a width extension, than a geometric extension, in particular a thickness extension, viewed along the thickness direction.

The fluid line section extending transversely to the extrusion direction preferably extends along or parallel to the width direction. However, the fluid line section extending transversely to the extrusion direction may also extend along or parallel to the thickness direction. It is also possible for the fluid line section extending transversely to the extrusion direction to run obliquely to the width direction and/or obliquely to the thickness direction.

In this context, the fact that the fluid line section extending transversely to the extrusion direction is "groove-shaped" means in particular that the fluid line section extending transversely to the extrusion direction comprises a bottom and two opposite side walls. The fluid line section is open opposite the bottom. This means that the fluid line section is initially open around its circumference. This applies to all fluid line sections extending transversely to the extrusion direction.

With the aid of the fluid guide block element or with the aid of the fluid line block cover, in particular with the aid of the first fluid guide block cover or with the aid of the second fluid guide block cover, this fluid line section, which is open on one side and extends transversely to the extrusion direction, is covered so that it is closed around its circumference. In other words, with the help of the fluid guide block element or with the help of the fluid line block cover, in particular with the help of the first fluid guide block cover or with the help of the second fluid guide block cover, a top is formed opposite the bottom of the groove-shaped fluid line section extending transversely to the extrusion direction. In this case, "circumferentially" closed means that the fluid line section extending transversely to the extrusion direction is closed around its entire circumference when the fluid guide block cover is adjacent to or rests on the fluid guide block element.

In this case, "transverse" means in particular that the fluid line sections extending transversely to the extrusion direction can extend perpendicular or obliquely to the extrusion direction. In the present case, "perpendicular" is understood in particular to mean an angle of 90° ± 10°, preferably 90° ± 5°, more preferably 90° ± 3°, more preferably 90° ± 1°, and more preferably exactly 90°.

According to one embodiment, the at least one fluid line section extending transversely to the extrusion direction is incorporated, in particular milled, into an end face of the fluid guide block element being oriented perpendicular to the extrusion direction.

An alternative manufacturing method for the fluid line section extending transversely to the extrusion direction is, for example, an erosion process. As mentioned above, the fluid guide block element comprises a first end face and a second end face. One or more fluid line sections extending transversely to the extrusion direction can be incorporated into both the first end face and the second end face. In the event that the fluid line sections extending transversely to the extrusion direction are incorporated into the first end face and/or the second end face of the fluid guide block element, the first fluid guide block cover and/or the second fluid guide block cover face the fluid guide block element and are preferably plane or smooth. Sealing elements, in particular in the form of flat gaskets, may be arranged between the fluid guide block covers and the fluid guide block element.

According to another embodiment, the at least one fluid line section extending transversely to the extrusion direction is incorporated, in particular milled, into the fluid guide block cover.

In this case, the first end face and/or the second end face of the fluid guide block element are plane or smooth. In other words, the fluid line sections extending transversely to the extrusion direction are not incorporated into the fluid guide block element. Alternatively, it is also possible, for example, that a fluid line section extending transversely to the extrusion direction is incorporated into one of the end faces of the fluid guide block element, whereas the other end face of the fluid guide block element is smooth. A fluid guide block cover is provided on this smooth end face of the fluid guide block element, which cover comprises at least one fluid line section extending transversely to the extrusion direction.

According to another embodiment, the fluid circuit comprises a plurality of fluid line sections extending parallel to the extrusion direction and a plurality of fluid line sections extending transversely to the extrusion direction, wherein the plurality of fluid line sections extending parallel to the extrusion direction are in fluid communication with each other by means of the plurality of fluid line sections extending transversely to the extrusion direction.

Preferably, exactly one fluid line section extending transversely to the extrusion direction is arranged between two fluid line sections extending along or parallel to the extrusion direction, and exactly one fluid line section extending along or parallel to the extrusion direction is arranged between two fluid line sections extending transversely to the extrusion direction. In other words, the fluid line sections extending along or parallel to the extrusion direction and the fluid line sections extending transversely to the extrusion direction are arranged alternately. This can result in multiple diversions of the fluid flow direction within the fluid guide block. Preferably, the fluid is deflected at least twice by 180° within the fluid guide block element. In particular, the fluid line sections extending transversely to the extrusion direction serve to deflect the fluid. Within the fluid line sections extending along or parallel to the extrusion direction, the fluid flows along or against the extrusion direction. Within the fluid line sections extending transversely to the extrusion direction, the fluid flows transversely to the extrusion direction, i.e., preferably along the width direction.

According to another embodiment, the plurality of fluid line sections extending parallel to the extrusion direction are spaced apart from each other and extend parallel to each other when viewed perpendicular to the extrusion direction.

In other words, the fluid line sections extending along or parallel to the extrusion direction are spaced apart from each other along the width direction. The fluid line sections extending along the extrusion direction are in fluid communication with each other only with the aid of the fluid line sections extending transversely to the extrusion direction when viewed perpendicular to the extrusion direction.

According to another embodiment, the plurality of fluid line sections extending parallel to the extrusion direction comprise cross-sectional geometries and/or cross-sectional areas that differ from one another.

In other words, the fluid line sections extending along or parallel to the extrusion direction may comprise different diameters, for example. For example, a fluid line section extending along or parallel to the extrusion direction through which the fluid is conveyed in liquid form may comprise a smaller diameter than a fluid line section extending along or parallel to the extrusion direction in which the fluid is conveyed in gaseous form. The fluid line sections extending along or parallel to the extrusion direction may comprise a circular cross-section. However, the fluid line sections extending along or parallel to the extrusion direction may also comprise an oval, rectangular, triangular, or any other cross-sectional geometry.

According to another embodiment, the fluid guide block cover is connected to the fluid guide block element by means of a screw connection, wherein a core hole of the screw connection extends parallel to the extrusion direction and is formed by plastic deformation on the fluid guide block element.

In other words, there is no need to subsequently insert core holes. An internal thread can be cut into the core hole. The screw connection may, for example, comprise any number of fastening elements, in particular screws, which are screwed into threaded holes in the fluid guide block element. The core holes of these threaded holes are preferably arranged at the edge of the fluid guide block element.

According to another embodiment, the fluid guide block cover is connected to the fluid guide block element by means of a form-fitting connection, wherein the form-fitting connection comprises a latching hook attached to the fluid guide block cover which is latched into the fluid guide block element.

A form-fitting connection is created by the interlocking or intermeshing of two connecting partners, in this case the first fluid guide block cover and/or the second fluid guide block cover and the fluid guide block element. Preferably, the form-fitting connection comprises a plurality of such latching hooks, which are latched or snapped into the fluid guide block element. The fluid guide block element may comprise undercuts for snapping in the latching hooks, with each latching hook being assigned to such an undercut. The latching hooks engage in the undercuts to connect the two fluid guide block covers to the fluid guide block element. Both a screw connection and a form-fitting connection may be provided between the fluid guide block covers and the fluid guide block element.

According to another embodiment, the fluid guide block comprises a filter and/or drying unit for filtering and/or drying the fluid, wherein the filter and/or drying unit is accommodated in the at least one fluid line section extending parallel to the extrusion direction.

As mentioned above, several fluid line sections are provided along or parallel to the extrusion direction, with the filter and/or drying unit being accommodated in one of these fluid line sections extending along or parallel to the extrusion direction. The filter and/or drying unit is replaceable. The filter and/or drying unit can, for example, be screwed into the second fluid guide block cover. Alternatively, the filter and/or drying unit can be replaced by removing the second fluid guide block cover from the fluid guide block element. The filter and/or drying unit is preferably cylindrical. To accommodate the filter and/or drying unit, the respective fluid line section extending along or parallel to the extrusion direction in which the filter and/or drying unit is accommodated comprises a correspondingly larger diameter than those fluid line sections extending along or parallel to the extrusion direction in which the filter and/or drying unit is not accommodated. During operation of the fluid guide block, the fluid line section extending along or parallel to the extrusion direction in which the filter and/or drying unit is accommodated can act as a buffer storage for the fluid. This fluid line section extending along or parallel to the extrusion direction can therefore also be referred to as a buffer storage or accumulator. Furthermore, the first fluid guide block cover and/or the second fluid guide block cover may each comprise a recess which, together with the fluid line section extending along or parallel to the extrusion direction in which the filter and/or drying unit is accommodated, acts as a buffer storage for the fluid.

According to another embodiment, the fluid guide block element comprises ribs, material reinforcements, stiffeners, and/or cavities that extend parallel to the extrusion direction and are formed on the fluid guide block element by means of plastic deformation.

The ribs or material reinforcements can be used to stiffen the fluid guide block element. Furthermore, an expansion valve of the heating and cooling module or of the fluid guide block, for example, can be supported by such a material reinforcement. The cavities serve, for example, to reduce weight.

According to another embodiment, the fluid guide block comprises a latent heat storage arranged within one of the cavities.

In this context, a "latent heat storage" is understood to be a heat storage that stores a large part of the thermal energy supplied to it in the form of conversion enthalpy. Materials such as salts or paraffins can be used for such a latent heat storage. In particular, so-called phase change materials (PCM) can be used.

According to another embodiment, the fluid guide block comprises an expansion valve that is in fluid communication with the fluid circuit, wherein the fluid guide block element supports the expansion valve, and wherein the expansion valve is arranged at least in sections within the fluid guide block element.

The expansion valve is preferably part of the fluid circuit. For example, the expansion valve is connected to one of the fluid line sections extending along or parallel to the extrusion direction. The expansion valve can be used to expand the fluid. The expansion valve is preferably also arranged at least in sections outside the fluid guide block. In particular, the expansion valve can be mounted on a material reinforcement of the fluid guide block element as mentioned above.

According to another embodiment, the fluid guide block comprises an insert for influencing a flow of the fluid, wherein the insert is accommodated in the at least one fluid line section extending parallel to the extrusion direction.

The insert can be arranged at any position in the fluid circuit. The insert can, for example, be spiral-shaped or helical. The insert can, for example, be an extruded component. The insert can comprise any geometry. The insert can, for example, comprise ribs and/or a defined surface structure. The insert can be a so-called turbulator. The insert can function as an internal heat exchanger within the fluid circuit. Any number and/or different inserts can be arranged within the fluid circuit.

Furthermore, a heating and cooling module is proposed comprising such a fluid guide block, a compressor that is in fluid connection with the fluid circuit, and at least one heat exchanger that is also in fluid connection with the fluid circuit.

The heating and cooling module may be suitable for use in a motor vehicle, in particular in a passenger car. Alternatively, the heating and cooling module may also be used in a building. The heating and cooling module may, for example, be part of an air conditioning system in the motor vehicle. The heating and cooling module can preferably operate in both heating mode and cooling mode. Accordingly, the heating and cooling module can also be referred to as an air conditioning module.

Preferably, the heating and cooling module is a heat pump or part of a heat pump. In this context, a "heat pump" is understood to be a machine which, by expending technical work, absorbs thermal energy from a low-temperature reservoir, in this case for example the surroundings, and - together with the drive energy - transfers it as usable heat to a system with a higher temperature to be heated, in this case for example the interior of the motor vehicle or the building. The heating and cooling module can therefore also be referred to as a heat pump heating and cooling module or a heat pump module.

In this case, a "module" is preferably understood to be a cuboid or box-shaped component that can be transported and installed as a single unit. The heating and cooling module is therefore preferably a transportable compact unit that can be carried by one person, for example. This allows the heating and cooling module to be used in a variety of ways. For example, several heating and cooling modules can be combined with each other.

According to one embodiment, the fluid guide block supports the at least one heat exchanger.

Preferably, a first heat exchanger and a second heat exchanger are provided. The heat exchangers are preferably screwed to the fluid guide block. The fluid guide block can support all components of the heating and cooling module.

The embodiments and features described for the proposed fluid guide block apply accordingly to the proposed heating and cooling module and vice versa.

"One" is not necessarily to be understood as limiting to exactly one element in the present case. Rather, several elements, such as two, three, or more, may also be provided. Nor is any other numeral used here to be understood as limiting to exactly the number of elements mentioned. Rather, numerical deviations upward and downward are possible, unless otherwise specified.

Further possible implementations of the fluid guide block and/or the heating and cooling module also include combinations of features or embodiments described previously or below with regard to the embodiments that are not explicitly mentioned. In doing so, the skilled person will also add individual aspects as improvements or additions to the respective basic form of the fluid guide block and/or the heating and cooling module.

Further advantageous designs and aspects of the fluid guide block and/or the heating and cooling module are the subject of the subclaims and the embodiments of the fluid guide block and/or the heating and cooling module described below. The fluid guide block and/or the heating and cooling module are explained in more detail below on the basis of preferred embodiments with reference to the accompanying figures.

### BRIEF DESCRIPTION OF THE DRAWINGS

FIG. 1 shows a schematic view of one embodiment of a heating and cooling system;

FIG. 2 shows a schematic perspective view of one embodiment of a heating and cooling module for the heating and cooling system according to FIG. 1;

FIG. 3 shows a further schematic perspective view of the heating and cooling module according to FIG. 2;

FIG. 4 shows another schematic perspective view of the heating and cooling module according to FIG. 2;

FIG. 5 shows a schematic perspective view of one embodiment of a first fluid guide block cover for the heating and cooling module according to FIG. 2;

FIG. 6 shows a schematic detailed sectional view of one embodiment of a fluid guide block for the heating and cooling module according to FIG. 2;

FIG. 7 shows a schematic perspective view of one embodiment of a second fluid guide block cover for the heating and cooling module according to FIG. 2;

FIG. 8 shows a schematic detailed sectional view of another embodiment of a fluid guide block for the heating and cooling module according to FIG. 2;

FIG. 9 shows another schematic detailed sectional view of the fluid guide block according to FIG. 8;

FIG. 10 shows a schematic sectional view of one embodiment of a fluid guide block element for the fluid guide block according to FIG. 8;

FIG. 11 shows a schematic view of another embodiment of a heating and cooling module for the heating and cooling system according to FIG. 1; and

FIG. 12 shows a schematic view of another embodiment of a heating and cooling module for the heating and cooling system according to FIG. 1.

### DETAILED DESCRIPTION

In the Figures, identical or functionally identical elements have been assigned the same reference numerals, unless otherwise specified.

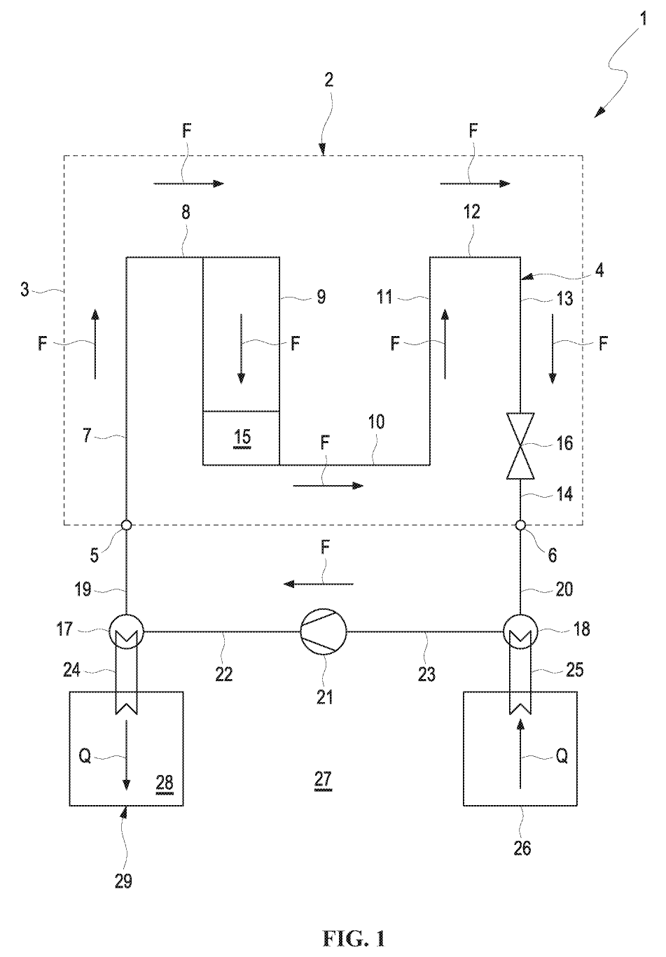

FIG. 1 shows a schematic view of an embodiment of a heating and cooling system 1.

The heating and cooling system 1 comprises a heating and cooling module 2 comprising a fluid guide block 3. The fluid guide block 3 may consist of several parts. A fluid circuit 4 is arranged inside the fluid guide block 3, in which a fluid F circulates. The fluid F can be a coolant or a refrigerant. Preferably, the fluid F is a refrigerant and can therefore also be referred to as such. Accordingly, the terms "fluid" and "refrigerant" can be used interchangeably in this context. The fluid circuit 4 can therefore be a refrigeration circuit or a refrigerant circuit. Accordingly, the terms "fluid circuit," "refrigeration circuit," and "refrigerant circuit" can be used interchangeably in the present context.

A "refrigerant" transports enthalpy from a refrigerated product to a surroundings. The difference between a "coolant" is that a refrigerant in a refrigeration cycle can transport enthalpy along a temperature gradient, so that, with the application of energy, the ambient temperature may even be higher than the temperature of the object being cooled, whereas a coolant is only capable of transporting enthalpy against the temperature gradient to a location with a lower temperature in a cooling cycle. Refrigerants such as 1,1,1,2-tetrafluoroethane (R-134a) and carbon dioxide (R744) can be used. Coolants such as water or oil can be used.

Since the fluid F circulating in the fluid circuit 4 is preferably a refrigerant, the fluid guide block 3 can also be referred to as a refrigerant guide block. Accordingly, the terms "fluid guide block" and "refrigerant guide block" can be used interchangeably in the present case. However, it is not excluded that a coolant can also circulate in the fluid guide block 3.

The fluid circuit 4 comprises an inlet 5 attached to the fluid guide block 3, through which the fluid F flows into the fluid guide block 3 during operation of the heating and cooling system 1, and an outlet 6, through which the fluid F flows out of the fluid guide block 3 during operation of the heating and cooling system 1. During operation of the heating and cooling system 1, the fluid F flows from the inlet 5 to the outlet 6. However, due to a reversal of the flow of the fluid F, it is also possible for the fluid F to flow from the outlet 6 to the inlet 5.

The fluid circuit 4 also comprises several fluid line sections 7, 8, 9, 10, 11, 12, 13, 14, with the aid of which the inlet 5 is fluidically connected to the outlet 6. The fluid line sections 7, 8, 9, 10, 11, 12, 13, 14 are arranged within the fluid guide block 3. During operation of the heating and cooling system 1, the fluid F is deflected or redirected multiple times by the fluid circuit 4 within the fluid guide block 3. In other words, the fluid circuit 4 is used to change or alter the flow direction of the fluid F multiple times within the fluid guide block 3. For example, the flow direction is deflected multiple times, in particular twice, by 180°. The fluid line sections 7, 8, 9, 10, 11, 12, 13, 14 are in fluid communication with each other. The number of fluid line sections 7, 8, 9, 10, 11, 12, 13, 14 is arbitrary.

The fluid line sections 7, 8, 9, 10, 11, 12, 13, 14 can be cavities, chambers, and/or channels arranged within the fluid guide block 3, which together form the fluid circuit 4. The fluid line sections 7, 8, 9, 10, 11, 12, 13, 14 may comprise different cross-sectional geometries and/or cross-sectional areas. For example, the fluid line section 9 comprises a larger cross-sectional area than fluid line sections 7, 8, 10, 11, 12, 13, 14, so that the fluid line section 9 can function as a buffer storage or accumulator for fluid F. The large-volume fluid line section 9 can function either as a high-pressure-side collector or as a low-pressure-side accumulator. A filter and/or drying unit 15 for filtering and/or drying the fluid F can be accommodated within the fluid line section 9 and thus also within the fluid guide block 3. The filter and/or drying unit 15 is replaceable.

There are basically two options for implementing a filter material in the filter and/or drying unit 15. In the first case, the filter material is a cylindrical component, whereby an adsorbent is absorbed by a carrier contour that gives the filter material its external shape. In the second case, the filter material is in the form of a geometrically undefined bag which holds the adsorbent and, when inserted into the filter and/or drying unit 15, takes on the inner contour of the latter. In particular, the filter and/or drying unit 15 can be designed as a collector or as a buffer within the fluid circuit 4.

The fluid circuit 4 further comprises an expansion valve 16, with the aid of which the fluid F can be expanded. The expansion valve 16 is a throttle or a throttle valve. Contrary to what is indicated in FIG. 1, the expansion valve 16 is preferably located at least partially outside the fluid guide block 3. However, the expansion valve 16 may also be arranged at least partially or completely within the fluid guide block 3.

The fluid line section 7 supplies the fluid line section 8 from the inlet 5. Thus, the fluid line section 8 is located downstream of the fluid line section 7. "Downstream" here means along a direction of flow of the fluid F in operation of the heating and cooling system 1 through the fluid circuit 4. The fluid line section 9 is located downstream of the fluid line section 8. The fluid line section 10 is located downstream of the fluid line section 9. The fluid line section 11 is located downstream of the fluid line section 10. The fluid line section 12 is located downstream of the fluid line section 11. The fluid line section 13 is located downstream of the fluid line section 12. The fluid line section 13 leads from the fluid line section 12 to the expansion valve 16. From the expansion valve 16, the fluid line section 14 leads to the outlet 6. The fluid line section 14 may be part of the outlet 6 or vice versa.

The heating and cooling module 2 further comprises a first heat exchanger 17, which functions as a condenser, and a second heat exchanger 18, which functions as an evaporator. The heat exchangers 17, 18 are located outside the fluid guide block 3. However, the heat exchangers 17, 18 are firmly connected to the fluid guide block 3, for example by means of screws. The heat exchangers 17, 18 are preferably so-called plate heat exchangers. The heat exchangers 17, 18 can be, for example, coolant/refrigerant heat exchangers or air/refrigerant heat exchangers.

The first heat exchanger 17 is in fluid communication with the inlet 5. An optional fluid line 19 may be provided for this purpose. The fluid line 19 may be a bore provided in the fluid guide block 3. In other words, the fluid line 19 may be arranged within the fluid guide block 3. The second heat exchanger 18 is in fluid communication with the outlet 6. An optional fluid line 20 may be provided for this purpose. The fluid line 20 may be a bore provided in the fluid guide block 3. In other words, the fluid line 20 may be arranged within the fluid guide block 3.

The heating and cooling module 2 also comprises a compressor 21 for compressing the fluid F. The compressor 21 is located outside the fluid guide block 3. The compressor 21 is in fluid communication with the first heat exchanger 17 by means of a pressure line 22 and with the second heat exchanger 18 by means of a suction line 23.

In addition to the heating and cooling module 2, the heating and cooling system 1 may comprise a first heat carrier medium circuit 24, which is thermally connected to the first heat exchanger 17, and a second heat carrier medium circuit 25, which is thermally connected to the second heat exchanger 18. A heat carrier medium, such as water or oil, circulates in each of the heat carrier medium circuits 24, 25. The heating and cooling system 1 also comprises a heat source 26. The heat source 26 supplies heat Q to the second heat exchanger 18 via the second heat carrier medium circuit 25. Alternatively, the heat Q can also be extracted from a surroundings 27 of the heating and cooling system 1.

The functionality of the heating and cooling system 1 in a heating mode is explained below. The heating and cooling system 1, in particular the heating and cooling module 2, functions as a heat pump. In this context, a "heat pump" is understood to be a machine which, by expending technical work, absorbs thermal energy from a reservoir with a lower temperature, in this case the heat source 26 or the surroundings 27, and - together with the drive energy - transfers it as useable heat to a system with a higher temperature to be heated, in this case an area 28 of a component 29 to be temperature-controlled.

The component 29 may be a motor vehicle, in particular a passenger car. The component 29 may therefore also be referred to as a motor vehicle. The area 28 may then be, for example, an interior or passenger compartment of the motor vehicle. However, the area 28 may also be a battery, in particular a rechargeable battery, or any other electrical or electronic component. Furthermore, the component 29 may also be a building. In this case, the component 29 may also be referred to as a building. The area 28 may then be an interior space of the building.

During operation of the heating and cooling system 1, the second heat exchanger 18 extracts heat Q from the heat source 26 or the surroundings 27. This extraction of heat Q can be carried out with the aid of the second heat carrier medium circuit 25, which extracts heat Q from the heat source 26 or the surroundings 27 and transfers it to the second heat exchanger 18. If the second heat exchanger 18 is an air/refrigerant heat exchanger, the second heat exchanger 18 can also extract the heat Q directly from the heat source 26 or the surroundings 27.

The second heat exchanger 18 functions as an evaporator to at least partially evaporate the fluid F, which in this case is a refrigerant. The fluid F absorbs heat Q in the process. After passing through the second heat exchanger 18, the fluid F is cold, has a low pressure, and is at least partially gaseous. This cold fluid F is supplied to the compressor 21 via the suction line 23 and compressed by the compressor 21. Downstream of the compressor 21, the fluid F has a high temperature and a high pressure and is at least partially gaseous.

The compressed fluid F is then supplied from the compressor 21 to the first heat exchanger 17 via the pressure line 22. The first heat exchanger 17 acts as a condenser. The gaseous fluid F condenses in the first heat exchanger 17 and transfers heat Q to the first heat carrier medium circuit 24. In the event that the first heat exchanger 17 is an air/refrigerant heat exchanger, the first heat exchanger 17 can also transfer the heat Q directly to the area 28 of the component 29. Downstream of the first heat exchanger 17, the fluid F is liquid, has a high pressure, and is warm.

The fluid F is then supplied downstream of the first heat exchanger 17 via the optional fluid line 19, the inlet 5, and the fluid line sections 7, 8, 9, 10, 11, 12, 13 of the fluid circuit 4 to the expansion valve 16, where the pressure is reduced. Downstream of the expansion valve 16, the fluid F is liquid, has a low pressure, and is very cold. The fluid F is supplied back to the second heat exchanger 18 via the fluid line section 14, the outlet 6, and the optional fluid line 20, where the fluid F again absorbs heat Q.

The heat Q transferred to the first heat carrier medium circuit 24 is released to the area 28 to heat it. To cool the area 28, the process described above can be reversed. The heating and cooling system 1 is then in cooling mode. To achieve this cooling mode, the heating and cooling system 1 may comprise several valves that can be switched so that the first heat exchanger 17 acts as an evaporator and the second heat exchanger 18 acts as a condenser.

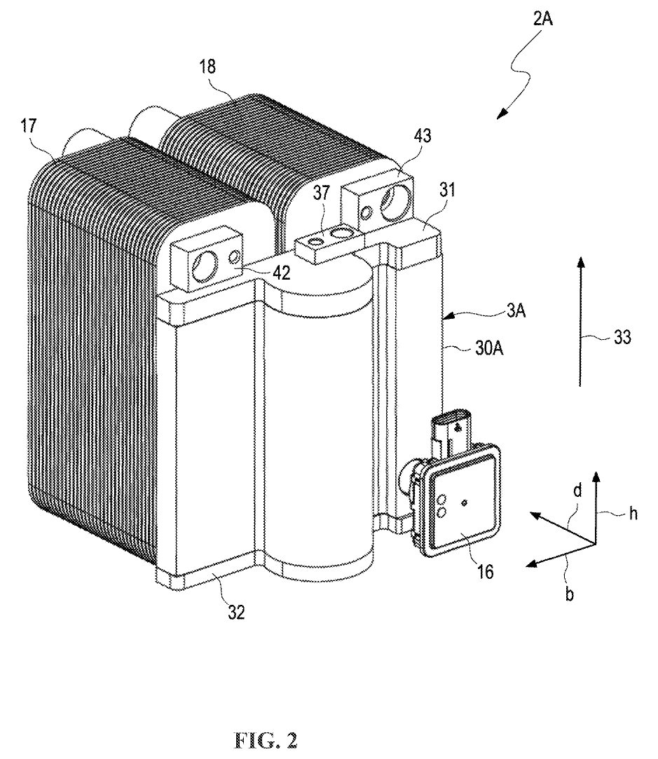

FIGS. 2 to 4 each show a schematic perspective view of one embodiment of a heating and cooling module 2A as described above. Reference will be made to FIGS. 2 to 4 simultaneously below.

The heating and cooling module 2A can be part of the heating and cooling system 1 mentioned above. The functionality of the heating and cooling module 2A corresponds to the functionality of the heating and cooling module 2. The heating and cooling module 2A represents a structural design of the heating and cooling module 2 shown in a highly schematic form in FIG. 1.

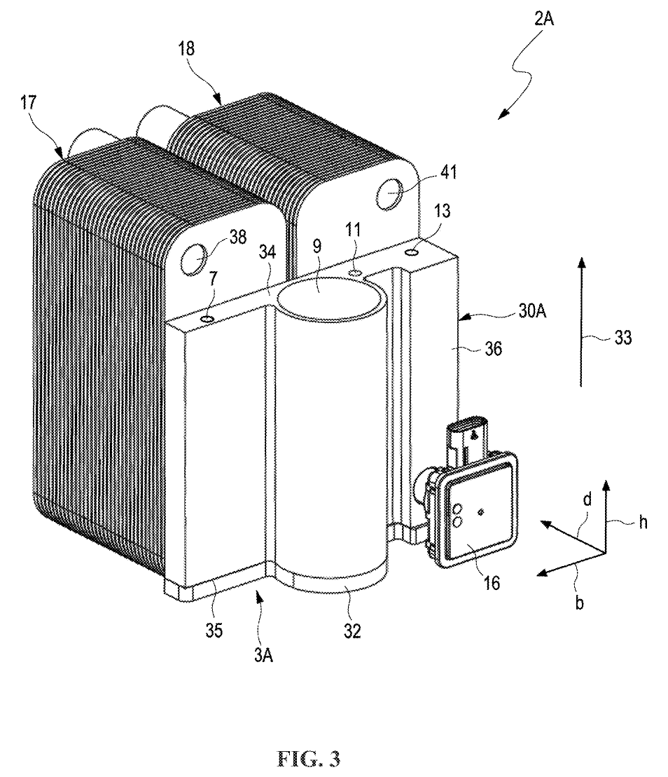

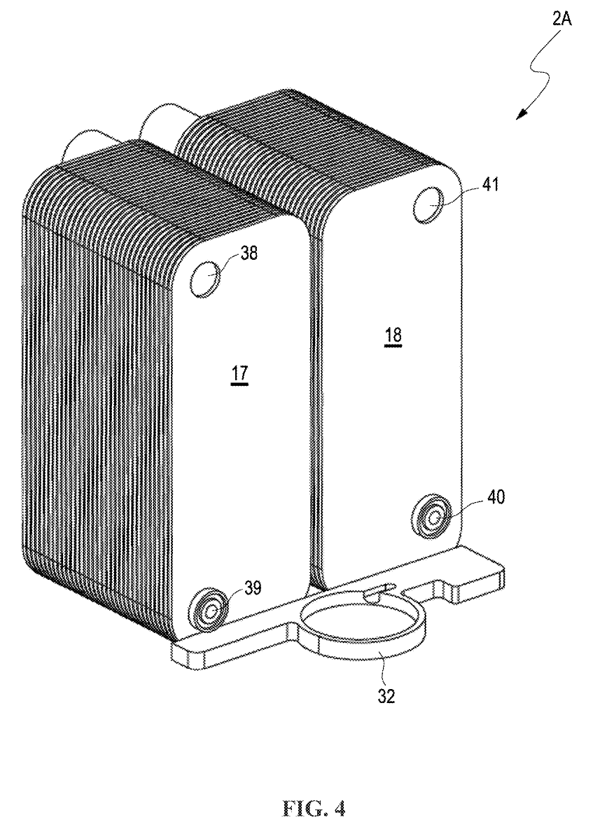

The heating and cooling module 2A comprises a fluid guide block 3A, which carries a first heat exchanger 17 as described above and a second heat exchanger 18 as described above. For this purpose, the heat exchangers 17, 18 are connected to the fluid guide block 3A, for example by means of screws. The fluid guide block 3Acomprises a fluid guide block element 30A, which is arranged between an upper or first fluid guide block cover 31 and a lower or second fluid guide block cover 32. In other words, the fluid guide block element 30A is arranged between the first fluid guide block cover 31 and the second fluid guide block cover 32. The fluid guide block element 30A is an integral or monolithic component. The first fluid guide block cover 31 is hidden (i.e., not shown) in FIGS. 3 and 4. The fluid guide block element 30A is hidden (i.e., not shown) in FIG. 4.

The fluid guide block covers 31, 32 are detachably connected to the fluid guide block element 30A. The fluid guide block covers 31, 32 can be snapped and/or screwed to the fluid guide block element 30A. A sealing element, for example in the form of a flat gasket, is arranged between the first fluid guide block cover 31 and the fluid guide block element 30A and between the second fluid guide block cover 32 and the fluid guide block element 30A.

The fluid guide block element 30A is an extruded component. In this context, "extrusion" refers to a manufacturing process in which a plastically deformable mass, in particular a semi-finished product or a raw part of the fluid guide block element 30A, is continuously pressed out under pressure from an opening, for example from an opening in a die.

The fluid guide block element 30A is preferably made of a metal alloy, in particular a light metal alloy. For example, the fluid guide block element 30A can be made of an aluminum alloy or a magnesium alloy. Alternatively, the fluid guide block element 30A can also be made of a plastic material. Suitable plastics include, for example, polyether ether ketones (PEEK).

If the fluid guide block element 30A is made of a metal alloy, the fluid guide block element 30A is preferably an extruded component or extruded profile. "Extrusion" is a primary shaping and plastic deformation process for producing profiles as continuous components. In this context, "continuous" refers to lengths of up to 60 m, for example. In extrusion, a billet heated to forming temperature is pressed through an opening in a die using a punch. Extrusion is therefore used to produce continuous material that can be cut to the desired length.

The fluid guide block element 30A is therefore preferably manufactured using a primary shaping and plastic deformation manufacturing process. In plastic deformation manufacturing processes, raw parts made of a malleable materials are deliberately given a different shape without removing or adding material from the raw parts. In plastic deformation manufacturing processes, a solid body with a geometrically defined shape is produced from a shapeless material. According to DIN 8583, extrusion is classified as a plastic deformation manufacturing process. DIN 8580, on the other hand, classifies extrusion as a primary forming manufacturing process. In accordance with DIN 8583, extrusion is assumed to be a plastic deformation manufacturing process.

An extrusion direction 33 is assigned to the fluid guide block element 30A. The extrusion direction 33 can also be referred to as the extrusion direction. In this context, the "extrusion direction" refers to the direction in which the fluid guide block element 30A is manufactured. In other words, the extrusion direction 33 is the direction in which a semi-finished product or raw part for manufacturing the fluid guide block element 30A is pressed through the aforementioned opening of the die. The extrusion direction 33 is oriented from bottom to top in the orientation of FIGS. 2 to 4. Alternatively, the extrusion direction 33 may also be oriented from top to bottom.

In addition to the extrusion direction 33, the fluid guide block element 30A is preferably assigned a height direction h, which may coincide with the extrusion direction 33, a width direction b, and a thickness direction d. The width direction b is oriented perpendicular to the extrusion direction 33 or the height direction h, whereby the thickness direction d is oriented both perpendicular to the extrusion direction 33 or the height direction h and perpendicular to the width direction b. Viewed along the width direction b and the height direction h, the fluid guide block element 30A comprises a greater geometric extension, in particular a width extension and a height extension, than a geometric extension, in particular a thickness extension, viewed along the thickness direction d.

The fluid guide block element 30A is manufactured as an endless component along the extrusion direction 33 and then cut to a desired length and reworked. Microscopically, manufacture by extrusion can be verified by a surface structure of the fluid guide block element 30A and/or a microstructure within the fluid guide block element 30A.

The aforementioned fluid line sections 7, 9, 11, 13 run inside the fluid guide block element 30A and parallel to or along the extrusion direction 33 or the height direction h. The fluid line sections 7, 9, 11, 13 run parallel to each other and when seen perpendicular to the extrusion direction 33, spaced apart from each other through the fluid guide block element 30A. The fluid line sections 7, 9, 11, 13 are formed by plastic deformation on the fluid guide block element 30A during extrusion or during extrusion molding. In other words, the fluid line sections 7, 9, 11, 13 are not subsequently introduced into the fluid guide block element 30A by means of a subtractive manufacturing process, such as drilling, milling, or eroding.

The fluid line sections 8, 10, 12, on the other hand, are preferably arranged within the fluid guide block covers 31, 32 and do not run along the extrusion direction 33, but transversely to the extrusion direction 33. In this context, "transverse" means that the fluid line sections 8, 10, 12 run either perpendicular or oblique to the extrusion direction 33. The fluid line sections 8, 12 are arranged within the first fluid guide block cover 31 and the fluid line section 10 is arranged within the second fluid guide block cover 32. In one embodiment, the fluid line sections 8, 10, 12 are groove-shaped.

In particular, the fluid line sections 8, 10, 12 run along or parallel to the width direction b. However, the fluid line sections 8, 10, 12 can also run along or parallel to the thickness direction d. It is also possible for the fluid line sections 8, 10, 12 to run at an angle to the width direction b and/or at an angle to the thickness direction d.

The fluid guide block element 30A comprises a first end face 34, against which the first fluid guide block cover 31 rests, and a second end face 35, which faces away from the first end face 34 and against which the second fluid guide block cover 32 rests. This does not exclude the possibility that sealing elements are arranged between the fluid guide block covers 31, 32 and the end faces 34, 35 as mentioned above. The end faces 34, 35 may be machined, for example milled. The fluid line sections 7, 9, 11, 13 run from the first end face 34 to the second end face 35. The fluid line sections 7, 9, 11, 13 are open towards both the first end face 34 and the second end face 35.

The fluid guide block element 30A comprises a material reinforcement 36 extending parallel to or along the extrusion direction 33, which may be web-shaped or rib-shaped. The material reinforcement 36 is formed onto the fluid guide block element 30A by plastic deformation during extrusion or extrusion molding of the fluid guide block element 30A. The material reinforcement 36 can support the expansion valve 16. In one embodiment, the fluid guide block element comprises ribs, material reinforcements, stiffeners, and/or cavities that extend parallel to the extrusion direction and are formed on the fluid guide block element by means of plastic deformation.

A bracket 37 for a pressure sensor, which can detect a pressure of the fluid F within the fluid circuit 4, is mounted on the first fluid guide block cover 31. The bracket 37 can be screwed to the first fluid guide block cover 31.

The first heat exchanger 17 comprises an inlet 38 through which the fluid F can flow into the first heat exchanger 17, and an outlet 39 through which the fluid F can flow out of the first heat exchanger 17. Accordingly, the second heat exchanger 18 comprises an inlet 40 through which the fluid F can flow into the second heat exchanger 18 and an outlet 41 through which the fluid F can flow out of the second heat exchanger 18.

A connecting piece 42 is mounted on the inlet 38 of the first heat exchanger 17. The connecting piece 42 can be screwed to the first heat exchanger 17. The pressure line 22 of the compressor 21 is connected to the connecting piece 42. The connecting piece 42 can be an integral part of the fluid guide block element 30A. A connecting piece 43 is mounted on the outlet 41 of the second heat exchanger 18. The connecting piece 43 can be screwed to the second heat exchanger 18. The suction line 23 of the compressor 21 is mounted on the connecting piece 43. The connecting piece 43 can be an integral part of the fluid guide block element 30A.

The outlet 39 of the first heat exchanger 17 is connected to the inlet 5 of the fluid guide block 3A. The inlet 5 may be a bore extending perpendicular to the fluid line section 7, which is formed in the fluid guide block element 30A. The inlet 40 of the second heat exchanger 18 is in fluid communication with the outlet 6 of the fluid guide block 3A. The outlet 6 opens into the fluid line section 14, which, together with the outlet 6, may also be a bore made in the fluid guide block element 30A, which extends perpendicular to the fluid line section 13 and is fluidically connected to it.

The expansion valve 16 may be arranged at least in sections within the outlet 6 and/or within the fluid line section 14. In the present case, the heating and cooling module 2A does not comprise the fluid lines 19, 20, since the heat exchangers 17, 18 are connected directly to the fluid guide block element 30A, in particular to the inlet 5 and the outlet 6.

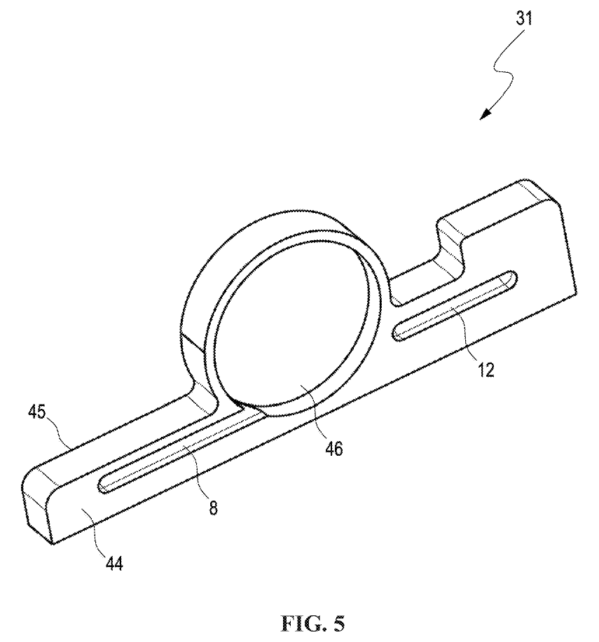

FIG. 5 shows a schematic perspective view of one embodiment of the first fluid guide block cover 31 as mentioned above.

The first fluid guide block cover 31 can be, for example, a milled component. The first fluid guide block cover 31 is preferably made of a metal alloy, in particular a light metal alloy. Preferably, the first fluid guide block cover 31 is made of the same material as the fluid guide block element 30A. The first fluid guide block cover 31 is an integral or monolithic component.

The first fluid guide block cover 31 comprises a first end face 44 facing the first end face 34 of the fluid guide block element 30A and a second end face 45 facing away from the first end face 44. The end faces 44, 45 are arranged parallel to each other and spaced apart from each other. The end faces 44, 45 can be machined using a subtractive manufacturing process, for example using a milling process.

The fluid line section 8, which extends transversely to the extrusion direction 33, is incorporated into the first end face 44. The fluid line section 8 is formed, for example, as a groove machined into the first end face 44 of the first fluid guide block cover 31. This means, in particular, that the fluid line section 8 is open towards the first end face 44. The fluid line section 8 connects the fluid line section 7 and the fluid line section 9 of the fluid guide block element 30A fluidically with each other. This means that the fluid F can flow from the fluid line section 7 via the fluid line section 8 into the fluid line section 9.

The fluid line section 8 opens into a recess 46 in the first fluid guide block cover 31, which is also incorporated into the first end face 44. The recess 46 is in fluid communication with the fluid line section 9. The recess 46 may, for example, be pot-shaped. The recess 46 can function as an accumulator or a buffer storage for the fluid F.

In the orientation of FIG. 5, next to the recess 46, the fluid line section 12, which also extends transversely to the extrusion direction 33, is incorporated into the first end face 44. The fluid line section 12 connects the fluid line sections 11, 13 of the fluid guide block element 30A, which run along the extrusion direction 33, to each other in a fluidic manner. However, no fluidic connection is provided between the two fluid line sections 8, 12 or between the recess 46 and the fluid line section 12.

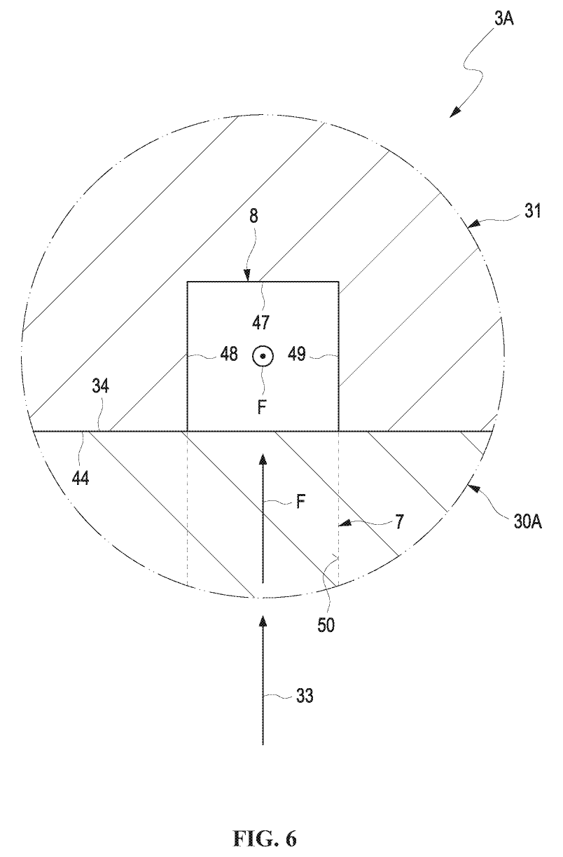

FIG. 6 shows a schematic detailed sectional view of the fluid guide block 3A.

In particular, FIG. 6 shows a detailed sectional view through the fluid line section 8 and perpendicular to the fluid line section 8. All subsequent descriptions concerning the fluid line section 8 are applicable to the fluid line sections 10, 12 accordingly. As shown in FIG. 6, the fluid line section 8 is a groove incorporated into the first end face 44 of the first fluid guide block cover 31, which extends transversely to the extrusion direction 33 and is open in the direction of the first end face 34 of the fluid guide block element 30A.

The fluid line section 8 comprises a bottom 47 and two side walls 48, 49 arranged parallel to each other and spaced apart from each other. Opposite the bottom 47, the fluid line section 8 is open in the direction of the first end face 34 of the fluid guide block element 30A. However, when the two end faces 34, 44 are in contact with each other, the first end face 34 of the fluid guide block element 30A closes the fluid line section 8 in such a way that it is closed around its circumference, so that no fluid F can escape in the direction of the first end face 34 of the fluid guide block element 30A.

In this case, "circumferentially" closed means that the fluid line section 8 comprises no opening at its circumference, which is formed or defined by the bottom 47, the two side walls 48, 49 and by a part of the first end face 34 of the fluid guide block element 30A, so that no opening is present, thereby ensuring that the fluid F cannot flow out of the fluid line section 8 circumferentially.

As FIG. 6 further shows, the fluid line section 7 opening into the fluid line section 8 comprises an inner surface 50 which may be cylindrical in shape. This means that the fluid line section 7 may be circular in cross-section. However, the fluid line section 7 may comprise any other cross-sectional geometry. The same applies to the fluid line sections 9, 11, 13.

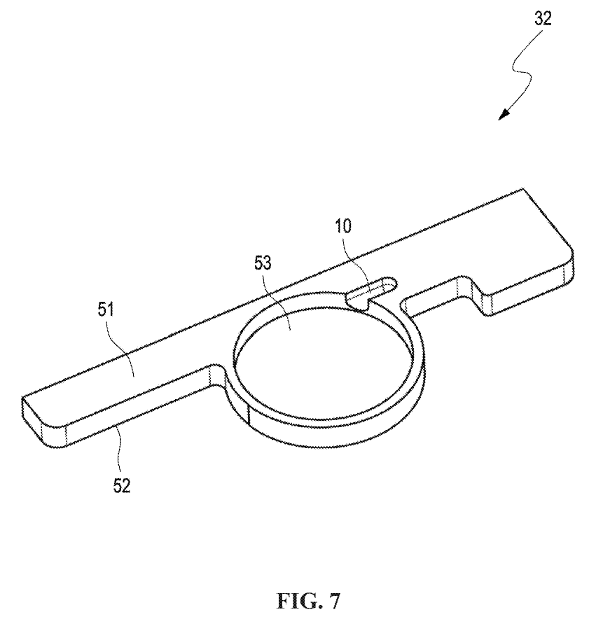

FIG. 7 shows a schematic perspective view of one embodiment of the second fluid guide block cover 32 as mentioned above.

The second fluid guide block cover 32 is preferably made of a metal alloy, in particular a light metal alloy. Preferably, the second fluid guide block cover 32 is made of the same material as the fluid guide block element 30A. The second fluid guide block cover 32 is an integral or monolithic component.

The second fluid guide block cover 32 comprises a first end face 51 facing the second end face 35 of the fluid guide block element 30A and a second end face 52 facing away from the first end face 51. The end faces 51, 52 are arranged parallel to each other and spaced apart from each other. The end faces 51, 52 can be machined using a subtractive manufacturing process, for example using a milling process.

The fluid line section 10, which also extends transversely to the extrusion direction 33, is formed as a groove in the first end face 51. As previously explained with reference to the fluid line section 8, the fluid line section 10 is covered in the direction of the fluid guide block element 30A by the second end face 35 of the fluid guide block element 30A, so that the fluid line section 10 is closed around its circumference.

Furthermore, a recess 53 is formed in the first end face 51. The recess 53 may be pot-shaped. The recess 53 is in fluid communication with the fluid line section 9. The recess 53 may serve as an accumulator or a buffer storage for the fluid F. The fluid line section 10 is in fluid communication with the recess 53. In other words, the fluid line section 10 opens into the recess 53.

Alternatively, the fluid line sections 8, 12 may also be incorporated into the first end face 34 of the fluid guide block element 30A and the fluid line section 10 into the second end face 35 of the fluid guide block element 30A. In this case, the first end faces 44, 51 of the fluid guide block covers 31, 32 are in a plane.

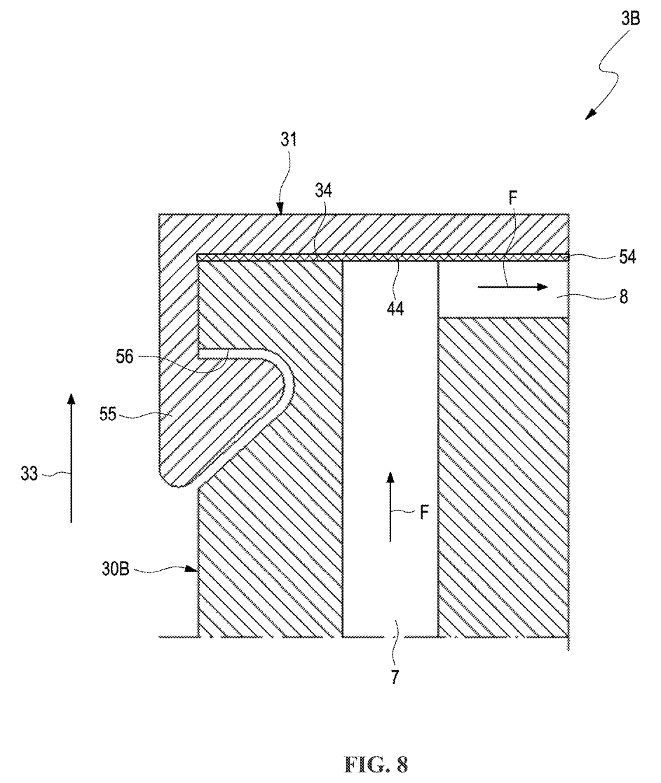

FIG. 8 shows a schematic detailed sectional view of another embodiment of a fluid guide block 3B.

The functionality of the fluid guide block 3B corresponds to the functionality of the fluid guide block 3A. In contrast to the fluid guide block 3A, the fluid guide block 3B comprises a fluid guide block element 30B in which the fluid line sections 8, 10, 12 extending transversely to the extrusion direction 33 are incorporated into the end faces 34, 35 of the fluid guide block element 30B. A sealing element 54 in the form of a flat gasket is arranged between the fluid guide block element 30B and the respective fluid guide block cover 31, 32.

The fluid guide block covers 31, 32 are each connected to the fluid guide block element 30B by means of a form-fitting connection. A form-fitting connection is created by the interlocking or intermeshing of two components, in this case the fluid guide block covers 31, 32 and the fluid guide block element 30B.

For this purpose, several latching hooks 55 are attached to the fluid guide block covers 31, 32, which engage positively in corresponding undercuts 56 of the fluid guide block element 30B. Only one of these latching hooks 55 is shown in FIG. 8. The fluid guide block covers 31, 32 can thus be snapped onto or into the fluid guide block element 30B. This enables quick assembly and disassembly of the fluid guide block 3B. The fluid guide block 3A can also comprise such latching hooks 55 and undercuts 56.

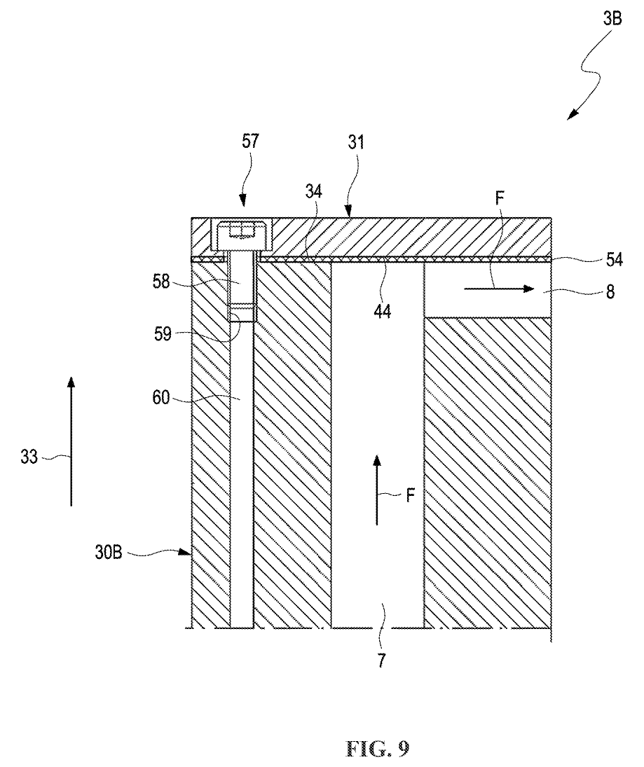

FIG. 9 shows a further schematic detailed sectional view of the fluid guide block 3B.

In this case, however, the fluid guide block covers 31, 32 are not connected to the fluid guide block element 30B by means of a form-fitting connection, but by means of a screw connection 57. The latching hooks 55 described above can be combined with the screw connection 57.

The screw connection 57 comprises several fastening elements 58, in particular in the form of screws, which are screwed into corresponding threaded holes 59 of the fluid guide block element 30B. Only one fastening element 58 is shown in FIG. 9. Core holes 60 of the threaded holes 59 run along or parallel to the extrusion direction 33 and are formed by plastic deformation on the fluid guide block element 30B. In other words, the core holes 60 are not introduced into the fluid guide block element 30B by a subtractive manufacturing process such as drilling. The fluid guide block 3A may also comprise such a screw connection 57.

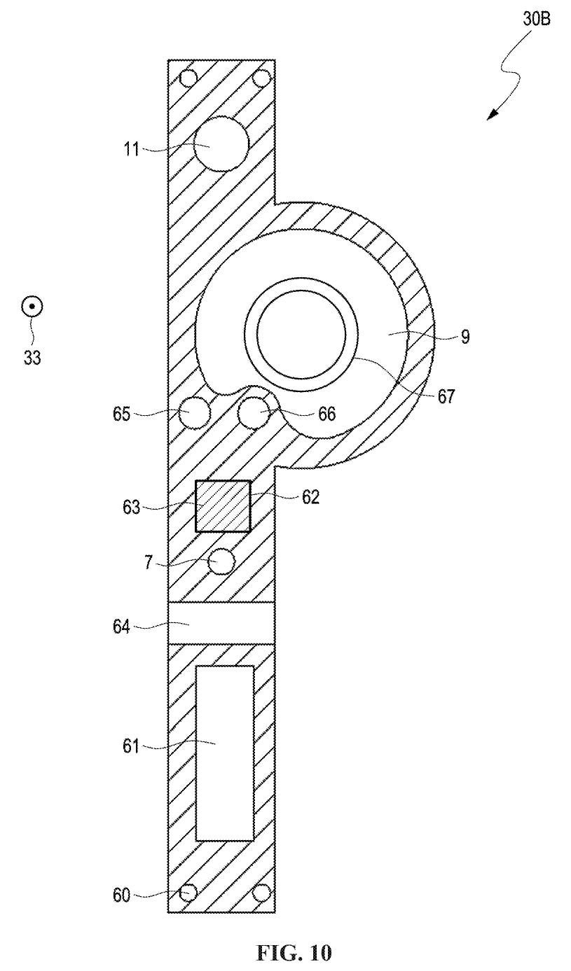

FIG. 10 shows a schematic cross-sectional view of the fluid guide block element 30B for the fluid guide block 3B.

The functionality of the fluid guide block element 30B corresponds to the function of the fluid guide block element 30A. In addition to the fluid line sections 7, 9, 11, 13 extending along or parallel to the extrusion direction 33, of which only the fluid line sections 7, 9, 11 are shown in FIG. 10, the fluid guide block element 30B also includes cavities 61, 62 extending along or parallel to the extrusion direction 33, which likewise extend from the first end face 34 to the second end face 35 and are formed integrally with the fluid guide block element 30B. For example, a latent heat storage 63, in particular in the form of a phase change material (PCM), can be arranged in one of the cavities 61, 62.

Furthermore, the fluid guide block element 30B may comprise a reworked transverse bore 64, for example to accommodate a valve. Additional channels 65, 66 extending along or parallel to the extrusion direction 33 may be formed on the fluid guide block element 30B.

An insert 67 may be arranged within one of the fluid line sections 7, 9, 11, 13. The insert 67 may comprise any geometry. For example, the insert 67 comprises a spiral or helical geometry. The insert 67 may be a so-called turbulator. The insert 67 may function as an internal heat exchanger within the fluid circuit 4. Any number and/or different inserts 67 may be arranged within the fluid circuit 4. In FIG. 10, the insert 67 is shown in a highly schematic form as a pipe. In one embodiment, the fluid guide block comprises an insert for influencing (e.g., configured to influence) a flow of the fluid, wherein the insert is accommodated in the at least one fluid line section extending parallel to the extrusion direction.

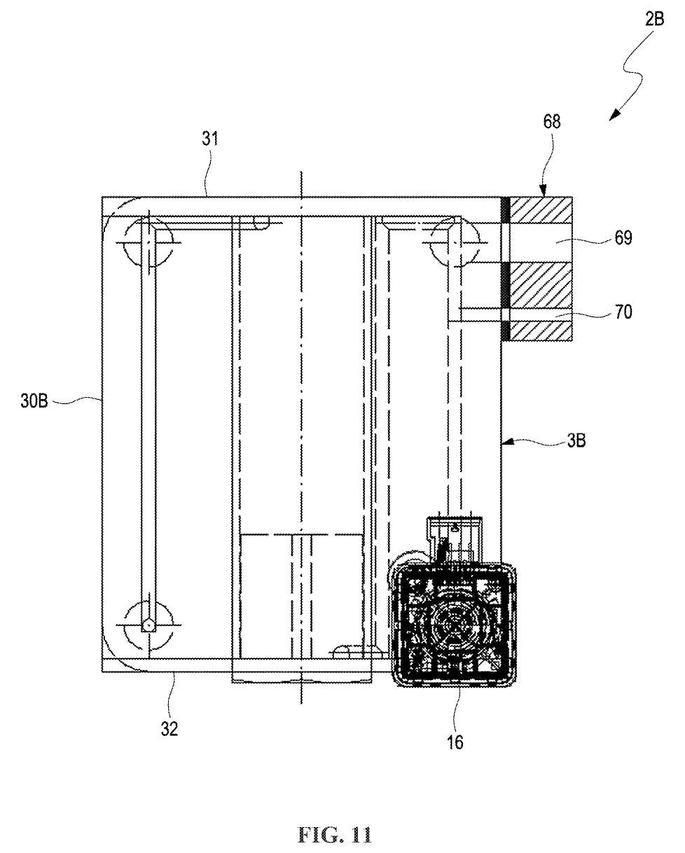

FIG. 11 shows a schematic view of another embodiment of a heating and cooling module 2B.

The heating and cooling module 2B comprises the aforementioned fluid guide block 3B with the fluid guide block element 30B. A connection flange 68 is flanged to the side of the fluid guide block 3B of the heating and cooling module 2B, in particular to the fluid guide block element 30B. The connection flange 68 comprises a suction line connection 69 and a liquid line connection 70.

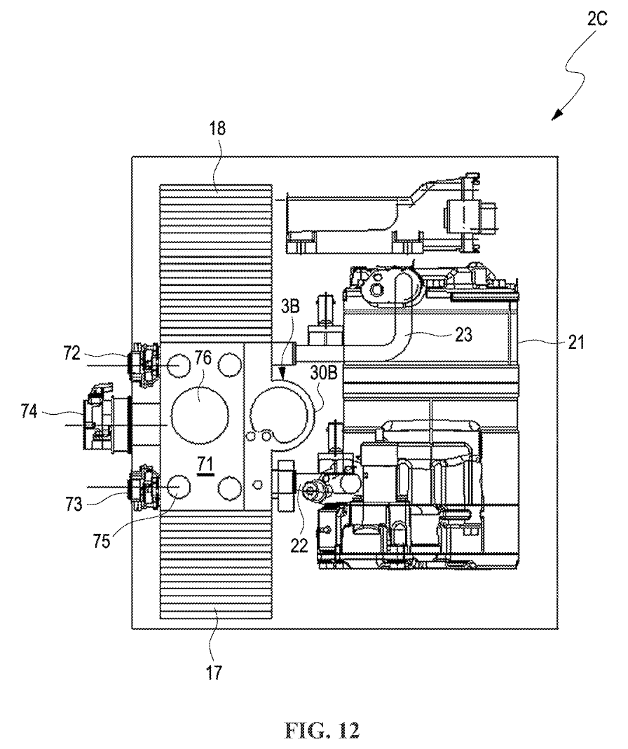

FIG. 12 shows a schematic view of another embodiment of a heating and cooling module 2C.

The heating and cooling module 2C comprises the aforementioned fluid guide block element 30B. In addition to the fluid guide block element 30B, the fluid guide block 3B comprises a further fluid guide block 71, which is also an extruded component, in particular an extruded component. The heat exchangers 17, 18 are flanged to the side of the fluid guide block 71.

The fluid guide block 71 supports water valves 72, 73 and a connection 74 to which a water pump can be connected. Furthermore, the fluid guide block 71 comprises several coolant guide channels 75, only one of which is provided with a reference symbol in FIG. 12. For example, four such coolant guide channels 75 are provided.

A channel 76 with a larger cross-section than the coolant guide channels 75 extends approximately centrally through the fluid guide block 71. A latent heat storage can be arranged in the channel 76.

Although the present invention has been described with reference to embodiments, it is modifiable in many ways.

### LIST OF REFERENCE SIGNS

1 Heating and cooling system

2 Heating and cooling module

2A Heating and cooling module

2B Heating and cooling module

2C Heating and cooling module

3 Fluid guide block

3A Fluid guide block

3B Fluid guide block

4 Fluid circuit

5 Inlet

6 Outlet

7 Fluid line section

8 Fluid line section

9 Fluid line section

10 Fluid line section

11 Fluid line section

12 Fluid line section

13 Fluid line section

14 Fluid line section

15 Filter and/or drying unit

16 Expansion valve

17 Heat exchanger

18 Heat exchanger

19 Fluid line

20 Fluid line

21 Compressor

22 Pressure line

23 Suction line

24 Heat carrier medium circuit

25 Heat carrier medium circuit

26 Heat source

27 Surroundings

28 Area

29 Component

30A Fluid guide block element

30B Fluid guide block element

31 Fluid guide block cover

32 Fluid guide block cover

33 Extrusion direction

34 End face

35 End face

36 Material reinforcement

37 Bracket

38 Inlet

39 Outlet

40 Inlet

41 Outlet

42 Connecting piece

43 Connecting piece

44 End face

45 End face

46 Recess

47 Bottom

48 Side wall

49 Side wall

50 Inner surface

51 End face

52 End face

53 Recess

54 Sealing element

55 Latching hook

56 Undercut

57 Screw connection

58 Fastening element

59 Threaded hole

60 Core hole

61 Cavity

62 Cavity

63 Latent heat storage

64 Transverse bore

65 Channel

66 Channel

67 Insert

68 Connection flange

69 Suction line connection

70 Liquid line connection

71 Fluid guide block

72 Water valve

73 Water valve

74 Connection

75 Coolant guide channel

76 Channel

b Width direction

d Thickness direction

F Fluid

h Height direction

Q Heat

What is claimed is:

1. A fluid guide block for a heating and cooling module, comprising:
a fluid guide block element;
a fluid guide block cover attached to the fluid guide block element; and
a fluid circuit arranged within the fluid guide block configured for guiding a fluid through the fluid guide block,
wherein the fluid guide block element is an extruded component,
wherein at least one fluid line section of the fluid circuit extends parallel to an extrusion direction of the fluid guide block element and is formed by plastic deformation on the fluid guide block element,
wherein at least one fluid line section of the fluid circuit extends transversely to the extrusion direction,
wherein the at least one fluid line section extending transversely to the extrusion direction is in fluid communication with the at least one fluid line section extending parallel to the extrusion direction,
wherein the at least one fluid line section extending transversely to the extrusion direction is groove-shaped, and
wherein the fluid guide block element or the fluid guide block cover circumferentially closes the at least one fluid line section extending transversely to the extrusion direction.

2. The fluid guide block according to claim 1, wherein the at least one fluid line section extending transversely to the extrusion direction is incorporated into an end face of the fluid guide block element and is oriented perpendicular to the extrusion direction.

3. The fluid guide block according to claim 1, wherein the at least one fluid line section extending transversely to the extrusion direction is incorporated into the fluid guide block cover.

4. The fluid guide block according to claim 1, wherein
the at least one fluid line section extending parallel to the extrusion direction comprises a plurality of fluid line sections extending parallel to the extrusion direction; and
the at least one fluid line section extending transversely to the extrusion direction comprises a plurality of fluid line sections extending transversely to the extrusion direction, wherein the plurality of fluid line sections extending parallel to the extrusion direction are in fluid communication with each other by the plurality of fluid line sections extending transversely to the extrusion direction.

5. The fluid guide block according to claim 4, wherein the plurality of fluid line sections extending parallel to the extrusion direction are spaced apart from each other and extend parallel to each other when viewed perpendicular to the extrusion direction.

6. The fluid guide block according to claim 4, wherein at least one of the plurality of fluid line sections extending parallel to the extrusion direction comprises a cross-sectional area that differs from the others of the plurality of fluid line sections extending parallel to the extrusion direction.

7. The fluid guide block according to claim 1, wherein the fluid guide block cover is connected to the fluid guide block element by a screw connection, wherein a core hole of the screw connection extends parallel to the extrusion direction and is formed by plastic deformation on the fluid guide block element.

8. The fluid guide block according to claim 1, wherein the fluid guide block cover is connected to the fluid guide block element by a form-fitting connection, wherein the form-fitting connection comprises a latching hook attached to the fluid guide block cover which is latched into the fluid guide block element.

9. The fluid guide block according to claim 1, comprising at least one of a filter or a drying unit configured for filtering or drying, respectively, the fluid, wherein the at least one of the filter or the drying unit is accommodated in the at least one fluid line section extending parallel to the extrusion direction.

10. The fluid guide block according to claim 1, wherein the fluid guide block element comprises at least one of ribs, material reinforcements, stiffeners, or cavities that extend parallel to the extrusion direction and are formed on the fluid guide block element by plastic deformation.

11. The fluid guide block according to claim 10, comprising a latent heat storage arranged within one of the cavities.

12. The fluid guide block according to claim 1, comprising an expansion valve that is in fluid communication with the fluid circuit, wherein the fluid guide block element supports the expansion valve, and wherein the expansion valve is arranged at least in sections within the fluid guide block element.

13. The fluid guide block according to claim 1, comprising an insert configured to influence a flow of the fluid, wherein the insert is accommodated in the at least one fluid line section extending parallel to the extrusion direction.

14. A heating and cooling module comprising:
a fluid guide block according to claim 1;
a compressor that is in fluid connection with the fluid circuit; and
at least one heat exchanger that is also in fluid connection with the fluid circuit.

15. The heating and cooling module according to claim 14, wherein the fluid guide block supports the at least one heat exchanger.

16. The fluid guide block of claim 3, wherein
the at least one fluid line section extending parallel to the extrusion direction comprises a plurality of fluid line sections extending parallel to the extrusion direction; and
the at least one fluid line section extending transversely to the extrusion direction comprises a plurality of fluid line sections extending transversely to the extrusion direction, wherein the plurality of fluid line sections extending parallel to the extrusion direction are in fluid communication with each other by the plurality of fluid line sections extending transversely to the extrusion direction.

17. The fluid guide block according to claim 6, wherein the at least one of the plurality of fluid line sections extending parallel to the extrusion direction that differs in the cross-sectional area from the others comprises a larger cross-sectional area than the others, wherein the fluid guide block comprises at least one of a filter or a drying unit configured for filtering or drying, respectively, the fluid, wherein the at least one of the filter or the drying unit is accommodated in the at least one fluid line section extending parallel to the extrusion direction having the larger cross-sectional area.
